(19) United States
(12) Patent Application Publication
(10) Pub. No.: US 2016/0136712 A1
(43) Pub. Date: May 19, 2016

(54) HEATING METHOD, HEATING APPARATUS, AND HOT PRESS MOLDING METHOD FOR PLATE WORKPIECE

(71) Applicant: NETUREN CO., LTD., Shinagawa-ku, Tokyo (JP)

(72) Inventors: Hironori OOYAMA, Shinagawa-ku, Tokyo (JP); Fumiaki IKUTA, Shinagawa-ku, Tokyo (JP)

(73) Assignee: NETUREN CO., LTD., Tokyo (JP)

(21) Appl. No.: 14/895,968

(22) PCT Filed: Jun. 2, 2014
(86) PCT No.: PCT/JP2014/065165

§ 371 Date: Dec. 4, 2015

(30) Foreign Application Priority Data
Jun. 5, 2013 (JP) 2013-119239

(51) Int. Cl. B21D 22/02; H05B 3/03; H05B 3/00; H05B 3/02; C21D 1/40; C21D 9/46

(52) U.S. Cl. CPC B21D 22/022; C21D 1/40; C21D 9/46; H05B 3/0004; H05B 3/023; H05B 3/03

(57) ABSTRACT

A heating method, a heating apparatus, and a hot press holding method for a plate workpiece are provided. The plate workpiece has a first region and a second region. A cross sectional area of the first region in a widthwise direction of the plate workpiece is substantially uniform along a longitudinal direction of the plate workpiece or is monotonically increased or decreased along the longitudinal direction. The second region is adjoining a portion of the first region in a monolithic manner. The method includes heating the second region, and heating at least the first region by direct resistance heating along the longitudinal direction. The second region is heated before heating the first region such that the first region and the second region are heated to be in a given temperature range.

### TECHNICAL FIELD

The present invention relates to a heating method and a heating apparatus for heating a plate workpiece having first and second regions, and a hot press molding method using the heating method and the heating apparatus.

### BACKGROUND ART

According to a related art method, a pair of electrodes is arranged to contact a workpiece, and electric current is applied between the pair of electrodes to heat the workpiece by direct resistance heating. This method can downsize a heating apparatus as compared with a furnace heating method in which a workpiece is heated in a furnace. However, with the direct resistance heating method, there may be an unevenness of heating temperature depending on a shape of a plate workpiece. Therefore, the direct resistance heating method has been used mostly to heat a plate workpiece having a simple shape, such as a band plate, a rectangular workpiece or the like.

In recent years, a direct resistance heating of a plate workpiece not having a simple shape has been proposed. For example, JP2011-189402A discloses a resistance heating method for heating a metal plate having a shape consisting of a plurality of shapes in the process of hot press molding of a vehicle part. According to the disclosure of JP2011-189402A, four or more electrodes are attached to a plate workpiece having a shape consisting of a plurality of shapes, and two of the electrodes are selected and are applied with electric current to uniformly heat the plate workpiece.

As another related art example, JP4563469B2 discloses a method in which a portion of a plate workpiece is quenched and pressed. According to this method, the width of the plate workpiece to be pressed is changed along the longitudinal direction so that, when electric current is applied to a pair of electrodes, there is a section having high current density, and this section is heated to a temperature that is equal to or higher than the quenching temperature. The other section is maintained at a temperature below the quenching temperature due to its low current density.

The heating apparatus disclosed in JP2011-189402A requires a number of electrodes to be attached to the plate workpiece to uniformly heat the plate workpiece. Therefore, the structure of the heating apparatus is complicated.

On the other hand, although it is possible to simplify the structure of a heating apparatus if only a portion of the plate workpiece having a complicated shape is heated as disclosed in JP4563469B2, when it is intended to uniformly heat the wide area of the plate workpiece, productivity is degraded as the shape of the plate workpiece needs to be adapted to the heat treatment.

When heating a plate workpiece having a shape consisting of a plurality of shapes by direct resistance heating, the electric current may be applied along the entire length in the longitudinal direction to simplify the structure of a heating apparatus.

However, because a cross sectional area of the workpiece in a direction perpendicular to the longitudinal direction increases or decreases between the longitudinal ends of the workpiece, simply applying the electric current between longitudinal ends generates a constricted portion or an expanded portion along a current-flowing path, making the current density distribution in the widthwise direction excessively non-uniform along the longitudinal direction. This consequently causes an excessively overheated or underheated portion along the longitudinal direction, and thus, cannot uniformly heat the entire workpiece.

### SUMMARY OF INVENTION

It is an object of the present invention to provide a heating method and a heating apparatus for easily heating a wide area of a complex-shaped plate workpiece to be in a given temperature range with a simple configuration, and to provide a hot press molding method using the heating method.

According to an aspect of the present invention, a method of heating a plate workpiece is provided. The plate workpiece has a first region and a second region. A cross sectional area of the first region in a widthwise direction of the plate workpiece is substantially uniform along a longitudinal direction of the plate workpiece or is monotonically increased or decreased along the longitudinal direction. The second region is adjoining a portion of the first region in a monolithic manner. The method includes heating the second region, and heating at least the first region by direct resistance heating along the longitudinal direction. The second region is heated before heating the first region such that the first region and the second region are heated to be in a given temperature range.

A width of the first region may be substantially uniform along the longitudinal direction or is monotonically increased or decreased along the longitudinal direction, and the second region may be adjoining the portion of the first region in the widthwise direction.

The plate workpiece may include a narrow portion and a wide portion arranged along the longitudinal axis of the plate workpiece. The wide portion is wider in the widthwise direction than the narrow portion. The first region may include the narrow portion and an extended portion defined in the wide portion by imaginary boundary lines, the imaginary boundary lines being extensions of both side edges of the narrow portion along the longitudinal axis.

The heating at least the first region may include arranging a pair of electrodes in the widthwise direction such that the pair of electrodes contacts a surface of the plate workpiece, and moving at least one of the electrodes with electric current being applied to the at least one of the electrodes. The heating the second region may include heating the second region to a temperature lower than the given temperature range, and the heating at least the first region may include further heating the second region together with the first region by direct resistance heating along the longitudinal direction. The heating the second region may include heating the second region to a temperature higher than the given temperature range.

A width of the first region may be substantially uniform along the longitudinal direction or is monotonically increased or decreased along the longitudinal direction, and the second region may be adjoining the portion of the first region in the longitudinal direction. The heating at least the first region may include further heating the second region together with the first region by direct resistance heating along the longitudinal direction.

The heating the second region may include heating the second region to a temperature lower than the given temperature range.

The heating the second region may include heating the second region by direct resistance heating, induction heating, furnace heating, or heater heating.

In these methods, it is preferable that the pair of electrodes is arranged in the widthwise direction such that the pair of electrodes contacts the surface of the plate workpiece, and the at least one of the electrodes is moved in the longitudinal direction while being applied with electric current, thereby heating the first region by direct resistance heating along the longitudinal direction.

According to another aspect of the present invention, an apparatus for heating a plate workpiece is provided. The plate workpiece has a first region and a second region. A width of the first region is substantially uniform along a longitudinal direction of the plate workpiece or is monotonically increased or decreased along the longitudinal direction. The second region is adjoining a portion of the first region in a widthwise direction or the longitudinal direction of the plate workpiece in a monolithic manner. The apparatus includes a first heating section configured to heat at least the first region, and a second heating section configured to heat the second region. The first heating section includes a pair of electrodes arranged in the widthwise direction such that the pair of electrodes contacts a surface of the plate workpiece to apply electric current to the plate workpiece. The first heating section may further include a drive unit configured to move at least one of the electrodes in the longitudinal direction in accordance with a variation in a cross sectional area of the plate workpiece with electric current being applied to the at least one of the electrodes.

The first heating section may be configured to heat the second region together with the first region

According to another aspect of the present invention, a hot press molding method is provided. The hot press molding method includes heating the first region and the second region by the foregoing method, and after the heating, pressing the first region and second region using a press mold.

According to another aspect of the present invention, a hot press molding method is provided. The hot press molding method includes heating at least a portion of the plate workpiece by direct resistance heating, and press molding the heated portion of plate workpiece using a press mold. The heating includes arranging a pair of electrodes in a width direction of the plate workpiece such that the pair of electrodes contacts a surface of the plate workpiece, and moving at least one of the electrodes in the longitudinal direction with electric current being applied to the at least one of the electrodes.

According to the heating method and heating apparatus described above, heating of the plate workpiece is performed by separately heating the plurality of regions including the first region and the second region adjoining a portion of the first region. Therefore, each region can be heated with a simplified shape. The cross sectional area of the first region in the widthwise direction is substantially uniform along the longitudinal direction or is monotonically increased or decreased along the longitudinal direction. Accordingly, when electric current is applied to the first region along the longitudinal direction, there is no constricted portion or expanded portion along the current-flowing path.

Therefore, when the first region is heated by direct resistance heating along the longitudinal direction, there is no portion where the current density distribution in the widthwise direction varies excessively. Thus, by heating the first region by direct resistance heating in accordance with a variation in cross sectional area of the first region along the longitudinal direction, the wide area of the first region can be easily heated in a substantially uniform manner, and the plate workpiece can be efficiently heated in the longitudinal direction.

Further, it is possible to heat a wide combined area of the first and second regions to be in a given temperature range by heating the second region adjoining the portion of the first region to be an adequate temperature, followed by heating the first region when the second region reaches an adequately heated state.

Furthermore, the first and second regions can be heated not concurrently but separately by heating the entire first region by direct resistance heating along the longitudinal direction, and by heating the second region using a suitable method. Therefore, it is possible to heat a wide combined area of the first and second regions with a simple configuration.

In a case in which the heating method is applied to a plate workpiece in which the second region is adjoining a portion of the first region in the widthwise direction in a monolithic manner, when the second region is first heated, the temperature of the second region is elevated, so that the second region has increased resistance as compared with the first region. Therefore, at the time of heating the first region by direct resistance heating, an amount of electric current flowing through the second region can be reduced, and a current-flowing path corresponding to the first region can be formed in the plate workpiece. Accordingly, it is possible to easily heat a wide area of the first and second regions to be in a given temperature range by heating the second region to be in an adequately heated state, followed by heating the first region by direct resistance heating along the longitudinal direction such that the first region is substantially uniformly heated over the wide area.

In a case in which the heating method is applied to a plate workpiece in which the second region is adjoining a portion of the first region in the longitudinal direction in a monolithic manner and the second region is wider than the first region, when the second region is first heated, the second region can be preheated. Therefore, when the second region is first heated to be in an adequately heated state and then the first and second regions are heated by direct resistance heating along the longitudinal direction, a wide area of the first and second regions can be easily heated to be in a given temperature range.

### BRIEF DESCRIPTION OF DRAWINGS

FIGS. 1A to 1D illustrate a plate workpiece heating method according to a first embodiment of the present invention.

FIGS. 2A to 2E illustrate a plate workpiece heating method according to a second embodiment of the present invention.

FIGS. 3A to 3C illustrate a plate workpiece heating method according to a third embodiment of the present invention.

FIG. 4 illustrate a hot press molding method according to a fourth embodiment of the present invention.

FIG. 5 illustrate a hot press molding method according to a modified example of the fourth embodiment of the present invention.

### DESCRIPTION OF EMBODIMENTS

Hereinafter, embodiments of the present invention will be described with reference to the drawings.

### First Embodiment

This embodiment illustrates an example in which a plate-lie workpiece W is heated and then quenched. In this embodiment, the plate workpiece W to be heated is a deformed plate made of steel, a shape of which will be formed into a shape of a product, specifically a B pillar of a vehicle.

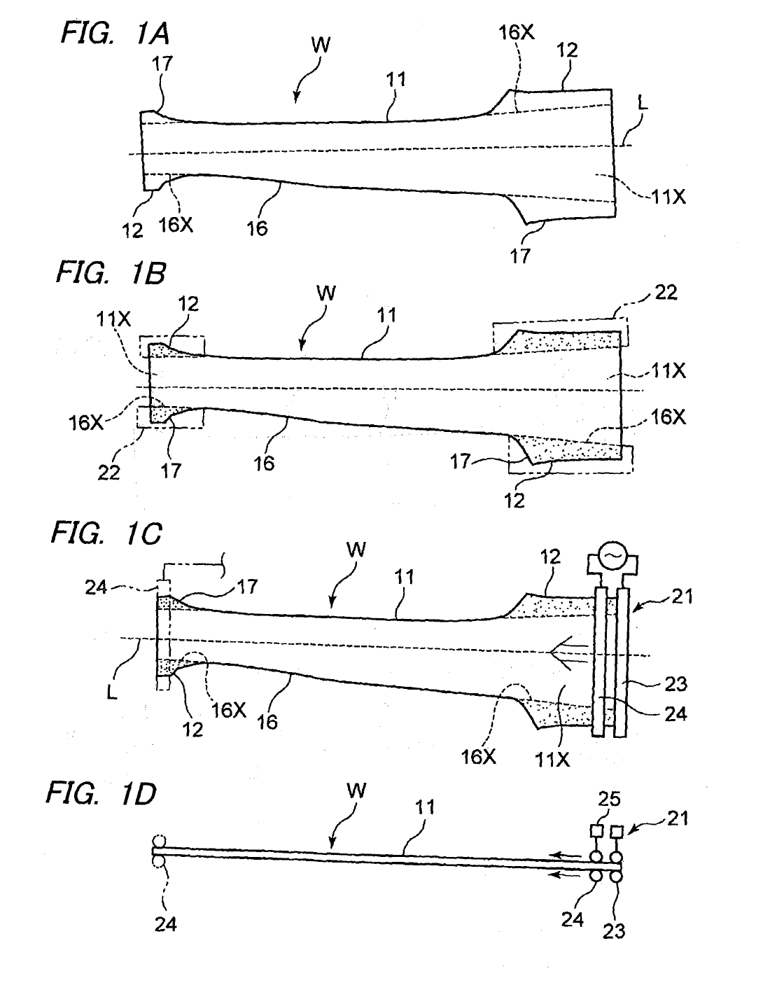

As shown in FIG. 1A, this plate workpiece W has a first region 11 and a plurality of second regions 12 adjoining a portion of the first region 11 in a monolithic manner. More specifically, the second regions 12 are adjoining the first region 11 on both sides of the first region 11 in the widthwise direction of the plate workpiece W at both ends of the first region 11 in the longitudinal direction of the plate workpiece W. A cross sectional area of the first region 11 in the widthwise direction of the plate workpiece W is monotonically increased or decreased along the longitudinal direction. The entire plate workpiece has a substantially uniform thickness. The width of the first region 11 is monotonically increased or decreased in the longitudinal direction.

The cross sectional area in the widthwise direction is monotonically increased or decreased in the longitudinal direction means that a variation in cross sectional area along the longitudinal direction, i.e. a cross sectional area at respective points along the longitudinal direction is increased or decreases in one direction without an inflection point. The cross sectional area can be considered as being monotonically increased or decreased, if a locally low-temperature portion or a locally high-temperature portion, which may be practically problematic, is not generated at the time of direct resistance heating due to current density being excessively non-uniform along the widthwise direction as a result of a sharp variation in the cross sectional area along the longitudinal direction. Alternatively, the cross sectional area in the widthwise direction may be substantially uniform continuously along the longitudinal direction.

In this embodiment, the plate workpiece W has a narrow portion 16 extending in the longitudinal axis L and wide portions 17 provided at both ends of the narrow portion 16 in a monolithic manner. The first region 11 includes the narrow portion 16 and extended portions 11X defined in the respective wide portions 17 by imaginary boundary lines 16X, the imaginary boundary lines 16X extensions of both side edges of the narrow portion 16 along the longitudinal axis L. The longitudinal axis L can be defined by a line extending along the longitudinal direction.

A heating apparatus for the plate workpiece W includes a first heating section 21 for heating the first region 11 as shown in FIGS. 1C and 1D, and a second heating section 22 for heating the second region 12 as shown in FIG. 1B.

The first heating section 21 includes a pair of electrodes 23, 24 arranged in the widthwise direction such that the pair of electrodes 23, 24 contacts the surface of the plate workpiece W, and a drive unit 25 configured to supply electric current to one of the electrodes 23 and at the same time, to move the electrode 23 in the longitudinal direction in accordance with a variation in cross sectional area.

In this embodiment, the first heating section 21 has the length sufficient for the pair of electrodes 23, 24 to traverse the whole width of the plate workpiece W. The pair of electrodes 23, 24 is brought into contact with the surface of the plate workpiece W such that the pair of electrodes traverses the first region 11 perpendicular to the longitudinal direction and parallel with each other. In addition, one of the electrodes 24 is moved in the longitudinal direction of the plate workpiece W by the drive unit 25 while being applied with electric current from a power supply. Each of the electrodes 23, 24 may be configured as a rotatable roller.

The drive unit 25 can move the electrode 24 from the large widthwise cross sectional area towards the small widthwise cross sectional area while controlling a motion speed. Here, a distance between the pair of electrodes 23, 24 can be increased in accordance with a variation in cross sectional area of the plate workpiece W in the longitudinal direction.

The control of the motion speed enables adjustment of current-flowing time at respective positions in the longitudinal direction such that the current-flowing time is extended at the large cross sectional area and the current-flowing time is shortened at the small cross sectional area. Consequently, the first region 11 can be controllably heated to be in a given temperature range, i.e. a temperature range allowable from a target temperature, over the entire area. It is preferable that this motion speed be controlled such that a heat generation rate per unit length at respective positions of the plate workpiece W in the longitudinal direction becomes as constant as possible based on various conditions such as, for example, a material, a shape, current value, a target temperature or the like of the plate workpiece W.

It is preferable that the second heating section 22 be designed to restrict heating of the first region 11 when heating the second region 12, as shown in FIG. 1B. For example, the second heating section may heat the second region by direct resistance heating using a pair of electrodes contacting the second region 12, by induction heating by moving a coil towards the second region 12, or by furnace heating by arranging and heating a portion of the second region 12 in a heating furnace. Alternatively, the second region may be heated by contacting a heater, which heats up to a certain temperature, to the second region.

When heating the second region 12 by direct resistance heating by contacting the pair of electrodes to the second region, high frequency current may be applied. When the high frequency current is used, an outer edge of the second region 12 is strongly heated due to the skin effect, so that it is easier to heat only the second region 12.

The plate workpiece W is heated in the following manner by the heating apparatus.

First, as shown in FIG. 1A, the plate workpiece W is divided into the first region 11 and the second region 12. Since the first region 11 and the second region 12 can be arbitrarily defined, the shapes of the regions are preferably defined as shapes that can be heated as easy as possible. Here, imaginary boundary lines 16X are formed at both longitudinal end sides of the plate workpiece W by imaginarily further extending both edges of the narrow portion 16 along the longitudinal axis L. Thereby, extended portions 11X are defined in the wide portions 17 by the imaginary boundary lines 16X. The narrow portion 16 and the extended portions 11X on both end sides thereof are collectively called the first region 11, and the portions between the imaginary boundary lines 16X and the side edges of the wide portions 17 are collectively called the second region 12.

Sequentially, as shown in FIG. 1B, the second regions 12 are disposed in and are heated by the second heating sections 22. Here, when only the second region 12 other than the first region 11 is heated, the second region 12 is heated to high temperature, whereas the first region 11 is maintained at low temperature. Thereby, resistance of the second region 12 becomes higher than that of the first region 11, thereby forming a current-flowing path for subsequent direct resistance heating of the first region 11.

When heating of the second region 12 is terminated, it is preferable that the second region 12 be heated to a temperature higher than a target heating temperature. Consequently, it is possible to heat the second region 12 to be in a given temperature range even when the temperature of the second region is lowered by heat dissipation until the first region 11 is subsequently heated by direct resistance heating.

Sequentially, after the second region 12 is heated, as shown in FIGS. 1C and 1D, the first region 11 is heated by direct resistance heating along the longitudinal direction by moving the electrode 24 in the longitudinal direction while supplying an electric current to the electrodes 23, 24 from power supply rolls by bringing the pair of the electrodes 23, 24 into contact with the plate workpiece W. As the electrode 24 is moved, at an initial heating stage, the first region 11 is applied with electric current for a partial range in the longitudinal direction. As the electrode 24 is further moved, a current-flowing range of the first region is enlarged. At a final heating stage, the current flows through the first region 11 over the substantially entire length.

Here, the second region 12 has been heated to high temperature, thereby increasing resistance of the second region 12. This allows the current to flow a lot through the first region 11 maintained at low temperature, thereby heating the first region 11. Thereby, the first region 11 is heated to be in a given temperature range close to a target temperature.

The first region 11 and the second region 12 are heated to be in a given temperature range by adjusting the heating temperature of the second region 12 and the heating timing of the first region 11. Meanwhile, according to the amount of time or heat transfer between the heating of the second region 12 and the direct resistance heating of the first region 11, the temperature of the second region 12 may often be lowered due to heat dissipation. To address this situation, the second region 12 may be further heated to higher temperature. In this case, the elevated temperature of the first region 11 and the lowered temperature of the second region become equal to each other. Thereby, the first region 11 and the second region 12 can be heated to be in a given temperature range. In this embodiment, the regions are thereafter rapidly cooled for quenching.

As set forth in the foregoing, the plate workpiece W is heated separately for the first region 11 and the second region 12 divided from the workpiece W. Because of this, respective regions are formed into simplified shapes to facilitate heating. The first region 11 of the two regions has the shape of which width monotonically increases or decreases in the longitudinal direction. Thus, the first region has no constricted portion or expanded portion along a current-flowing path. Here, when the current flows in the longitudinal direction, the current does not smoothly flow through the expanded portion.

Accordingly, when the current flows through the first region 11 so as to resistance heat the first region, there is no site where current density distribution in the widthwise direction varies excessively. Accordingly, when the first region 11 is heated by direct resistance heating in accordance with a variation in cross sectional area of the first region 11 along the longitudinal direction, a wide area of the first region 11 can be easily and uniformly heated, and the plate workpiece W can be efficiently heated in the longitudinal direction.

Further, when the first region 11 is heated after the second region 12 becomes an adequately heated state, a wide combined area of the first and second regions 11, 12 can be heated to be in a given temperature range.

Furthermore, since respective regions are not required to be heated at the same time, the entire first region 11 can be heated by direct resistance heating along the longitudinal direction, and the second region 12 can be heated by a method that is suitable for the second region 12, it is possible to heat a wide combined area of the first and second regions 11, 12 with a simple configuration.

Further, the plate workpiece W is formed such that the second region 12 is adjoining a portion of the first region 11 in the widthwise direction in a monolithic manner. Therefore, when the second region 12 is first heated, the current-flowing path corresponding to the first region 11 is formed in the plate workpiece W. Accordingly, a wide area of the first and second regions 11, 12 can be easily heated to be in a given temperature range by uniformly heating the first region over the wide area via longitudinal direct resistance heating after heating the second region 12 to an adequately heated state.

The first embodiment has illustrated an example in which imaginary boundary lines 16X are formed by imaginarily extending the both edges of the narrow portion 16, thereby defining the first region 11. However, the imaginary boundary lines 16X may be formed such that the width of the respective ends of the first region 11 is maintained to be constant in the longitudinal direction. In this case, when the first region 11 is heated by bringing the pair of electrodes 23, 24 into contact with the first region 11, the electrodes is moved in a short time over the extended portions 11X more rapidly than over other region, thereby uniformly heating the entire area of the first region.

Furthermore, when the first region 11 is provided on other partial area with the portion where a widthwise cross sectional area is maintained to be constant in the longitudinal direction, the electrodes 23, 24 are also moved in a short time over that portion more rapidly than over other portion, thereby uniformly heating the first region 11.

### Second Embodiment

Next, a second embodiment will be described. The plate workpiece W here is similar to the plate workpiece W in the first embodiment. That is, the plate workpiece W includes, as a monolithic structure, a narrow portion 16 extending along the longitudinal axis L, a first wide portion 17a provided on one end of the narrow portion 16, and a second wide portion 17b wider than the first wide portion 17a and provided on the other end of the narrow portion 16. The workpiece W has a first region 11 provided along the longitudinal direction over the entire length of the workpiece W, a cross sectional area of the first region 11 in the widthwise direction being monotonically increased from one end to the other end in the longitudinal direction, a second region 12a provided in the first wide portion 17a and adjoining the first region 11 from both sides in the widthwise direction at one end of the first region 11, and another second region 12b provided in the second wide portion 17b and adjoining from both sides in the widthwise direction at the other end of the first region 11.

In this embodiment, the plate workpiece W is partially heated in a different temperature range and then is cooled, thereby forming a portion having different properties. Specifically, the second wide portion 17b is heated in a first temperature range and the remaining portion except the second wide portion 17b is heated in a second temperature range higher than the first temperature range, and then the workpiece is cooled. This consequently makes it possible for the second wide portion 17b and the remaining portion except the second wide portion 17b to have different properties.

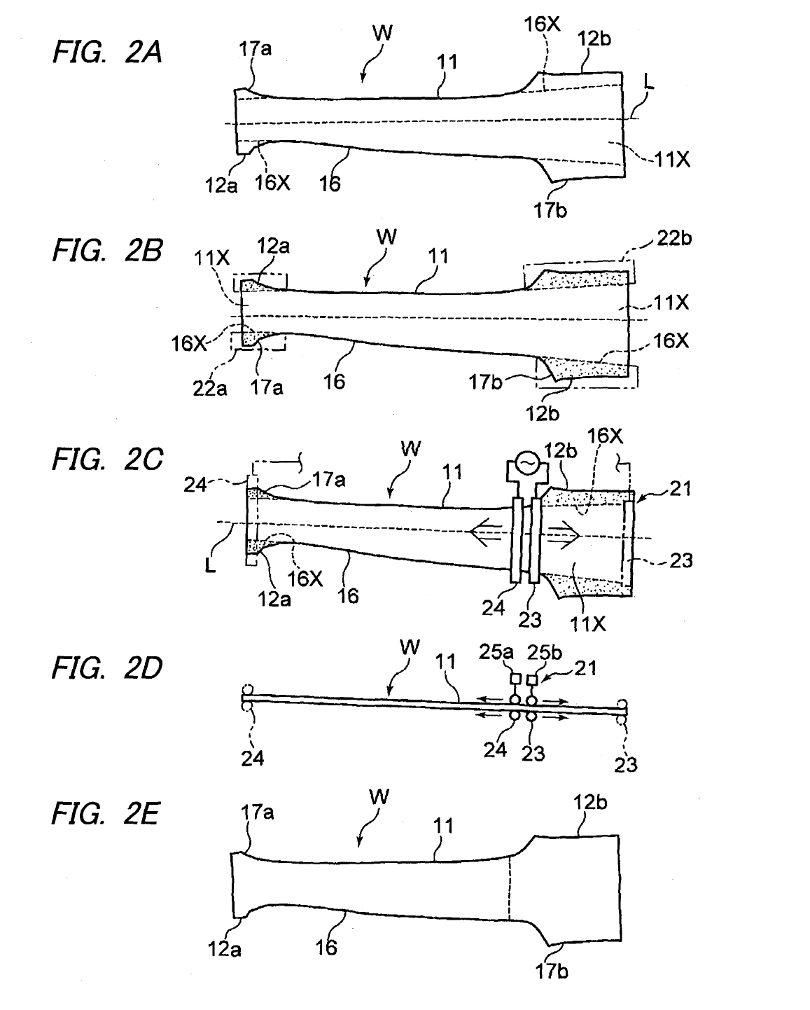

The heating apparatus used in this embodiment has the same as in the first embodiment, except that the first heating section 21 is different from that of the first embodiment. As shown in FIGS. 2 C and 2D, the first heating section 21 of this heating apparatus is configured such that an electrode 24 has a width that is smaller than that of the second wide portion 17b and corresponds to the maximum width of the first region 11, and a pair of electrodes 23, 24 can be respectively moved in the longitudinal direction on the plate workpiece W by drive units 25a, 25b. The other configuration is the same as in the first embodiment.

To heat the plate workpiece W using this heating apparatus, as in the first embodiment, the plate workpiece W is divided into a plurality of sub-regions, thereby forming the first region 11 and the second regions 12a, 12b as shown in FIG. 2A.

Subsequently, as shown in FIG. 2B, the second regions 12a, 12b are respectively arranged and heated in the second heating sections 22a, 22b. When the regions are heated, it is preferable that the second regions 12a in pair on one side be heated to a temperature higher than the second temperature range and the second regions 12b on the other side be heated to a temperature higher than the first temperature range.

When the first region 11 is maintained at a low temperature state and the second regions 12a, 12b are heated in a high temperature state as described above, resistance of the second regions 12a, 12b become larger than that of the first region 11, thereby forming a current-flowing path for the subsequent direct resistance heating of the first region 11.

Subsequently, as shown with solid line in FIGS. 2C and 2D, the pair of electrodes 23, 24 is brought into contact with an intermediate part of the first region 11, specifically a portion adjacent to a boundary between the narrow portion 16 and the second wide portion 17b of the plate workpiece W. Here, the electrodes 23, 24 in a pair are respectively arranged substantially in parallel and substantially perpendicular to the longitudinal direction so as to traverse the first region 11.

The respective electrodes 23, 24 are moved over the entire length of the first region 11 in the longitudinal direction while being applied with a substantially constant electric current from a power supply unit. Thereby, the first region 11 is heated by direct resistance heating over the entire length along the longitudinal direction. The electrodes 24 are moved toward one side by the drive unit 25a whereas the electrodes 23 are moved toward the other side by the drive unit 25b. Consequently, at an initial direct resistance heating stage, the first region 11 is applied with electric current for a partial range in the longitudinal direction. Then, as the electrodes 23, 24 are moved away from each other, a current-flowing range of the first region is enlarged. At a final heating stage, the current flows through the first region 11 over the substantially entire length.

Here, it is preferable that the order, speed or the like when the respective electrodes 23, 24 are moved be adjusted according to a variety of heating conditions such as a shape, a target temperature range, or the like of the first region 11.

The movement order may be adjusted such that, for example, the electrodes 23, 24 are moved at the same time, or otherwise the electrodes 24, which require a long current-flowing time, are first moved and then the electrodes are moved. The motion speed may be adjusted such that, for example, the electrodes 23, 24 are moved at different speeds, or otherwise the electrodes 23 are moved at a variable speed in accordance with a variation in widthwise cross sectional area of the first region 11 along the longitudinal direction.

The respective positions of the first region 11 are heated in a target temperature range by adjusting the movement order, the motion speed or the like of the respective electrodes 23, 24 in such a way as to adjust a current-flowing time at respective longitudinal positions such that the current-flowing time is increased at the large cross sectional area, and the current-flowing time is decreased at the small cross sectional area. Here, the first region 11 in the second wide portion 17b is heated in a first temperature range, and the first region 11 in the remaining portion is heated in a second temperature range.

As described above, the respective positions of the first region 11 can be heated in a state where the second regions 12a, 12b are previously heated. Here, the entire portion of the second wide portion 17b can be heated in a first temperature range and the entire portion of the remaining portion can be heated in a second temperature range by adequately adjusting the heating temperature of the second regions 12a, 12b, the heating timing of the first region 11, or the like. Thereby, as shown with a dotted line in FIG. 2E, the plate workpiece W may have a plurality of temperature regions. According to this embodiment, the workpiece is thereafter rapidly cooled to complete the quenching.

It is also possible to have the similar effects as in the first embodiment when the plate workpiece W is heated according to the method described above. Particularly, according to the second embodiment, the workpiece is separately heated at different temperatures for the first region 11 and the second regions 12a, 12b. Thereby, the respective regions can be heated to be in different temperature ranges.

Although the second embodiment employs the plate workpiece W of which thickness is generally constant, a tailored blank type workpiece having different-thickness regions can also be employed. For example, this embodiment can employ the plate workpiece W in which the second wide portion 17b and the remaining portion have different thicknesses which will be heated the same manner as described above. In this case, it is easy to heat the second wide portion 17b and the remaining portion in the same temperature range. Even when the workpiece has a uniform thickness, the workpiece may be heated to be in the same temperature range in a similar manner.

### Third Embodiment

Next, a third embodiment will be described.

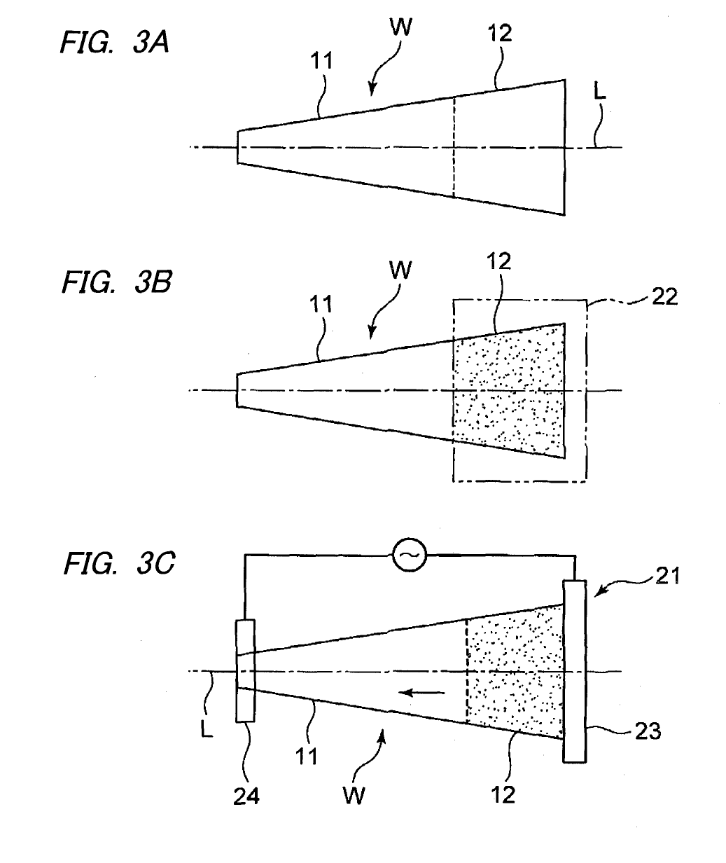

As shown in FIG. 3A, the plate workpiece W in this embodiment includes a first region 11 which has a substantially trapezoidal shape of which thickness is substantially uniform over the entire range and of which widthwise cross sectional area monotonically increases or decreases in the longitudinal direction, and a second region 12 of which width is larger than that of the first region 11.

A heating apparatus for the plate workpiece W includes a first heating section 21 which heats the first region 11 and the second region 12, and a second heating section 22 which heats the second region 12 as shown in FIGS. 3B and 3C.

The second heating section 22 be designed to restrict heating of the first region 11, but heat the second region 12 as shown in FIG. 3B. For example, the second heating section may heat the second region by direct resistance heating by bringing a pair of electrodes into contact with the second region 12, by induction heating by moving a coil towards the second region 12, or by furnace heating by arranging and heating a portion of the second region 12 in a heating furnace. Alternatively, the second region may be heated by contacting a heater, which is heated up to a certain temperature, to the second region. In this embodiment, only the second region 12 is arranged and heated in the heating furnace.

The first heating section 21 includes electrodes 23, 24 in a pair which are brought into contact with the surface of the plate workpiece W substantially in parallel to each other in the widthwise direction as shown in FIG. 3B. The first heating section is designed to supply a constant amount of current from a power supply unit to the workpiece in the longitudinal direction.

The plate workpiece W is heated in the following manner by the heating apparatus.

First, as shown in FIG. 3A, the plate workpiece W is divided into a plurality of regions to define a first region 11 and a second region 12 in order to heat the workpiece as uniform as possible. Here, the region having a large widthwise cross sectional area is defined as the second region. The second region having the large cross sectional area is the region that is difficult to obtain a sufficient current density when direct resistance heating is carried out using the pair of electrodes 23, 24. In addition, the region of which widthwise cross sectional area is smaller than that of the second region is defined as the first region.

Subsequently, as shown in FIG. 3B, the second region 12 is arranged and heated in the second heating section 22. A heating furnace is used as the second heating section 22, so that the second region is partially arranged and heated in the heating furnace. It is preferable that the second region be preheated to an adequate temperature lower than a target heating temperature range.

After the second region 12 is heated, as shown in FIG. 3C, the pair of electrodes 23, 24 is brought into contact with the surface on both sides of the plate workpiece W. The electrodes 23, 24 are applied with constant current from the power supply unit so that the electrodes carry out direct resistance heating along the longitudinal direction. Here, when the first region 11 is applied with electric current such that the first region is heated in a predetermined temperate range, the second region 12 has a heat generation rate per unit area that is lower than that of the first region 11 since the second region 12 has a wider width. Since the second region 12 however is adequately preheated, the entire first region and the entire second region can be heated to be in a given temperature range by direct resistance heating. In this embodiment, quenching is performed by subsequent rapid cooling.

According to the heating method and apparatus as set forth in the foregoing, the plate workpiece W is heated separately for the first region 11 and the second region 12 adjoining a portion of the first region 11. Because of this, respective regions are formed into simplified shapes to facilitate heating. The workpiece W has a shape in which the widthwise cross sectional area of the first region and the second region monotonically increases or decreases in the longitudinal direction. Thus, the workpiece has no constricted portion or expanded portion along a current-flowing path. Here, when the current flows in the longitudinal direction, the current does not smoothly flow through the expanded portion. Accordingly, when the first region 11 is heated by direct resistance heating in accordance with a variation in cross sectional area along the longitudinal direction, a wide area of the first region 11 can be easily and uniformly heated. Thereby, the plate workpiece W can be efficiently heated in the longitudinal direction.

Further, the second region 11 that is wider than the first region 11 is adjoining the first region 11 in the longitudinal direction of the plate workpiece W in a monolithic manner. Accordingly, when the second region 12 is first preheated and then the entire regions along the entire length is heated by direct resistance heating, the entire portion of the plate workpiece W need not be preheated, and it is easy to carry out direct resistance heating along the longitudinal direction. Consequently, the second heating section 22 can be miniaturized, and the entire apparatus can be made compact.

Although the third embodiment has illustrated the plate workpiece W which has a trapezoidal shape in which a widthwise cross sectional area of the first and second regions 11, 12 monotonically increases or decreases, the present invention is not limited thereto. For example, the present invention can of course be adapted to the workpiece in which the first and second regions 11, 12 respectively have cross sectional areas that are different widthwise, but are substantially uniform longitudinally.

### Fourth Embodiment

Next, a fourth embodiment will be described. This embodiment illustrates an example of performing hot press molding.

In this embodiment, a plate workpiece W, which may be of a various kind, is heated using the heating method and the heating apparatus of one of the first to third embodiments described above, and then is hot press-molded, instead of being quenched, by pressing the workpiece being in a high temperature state using a mold.

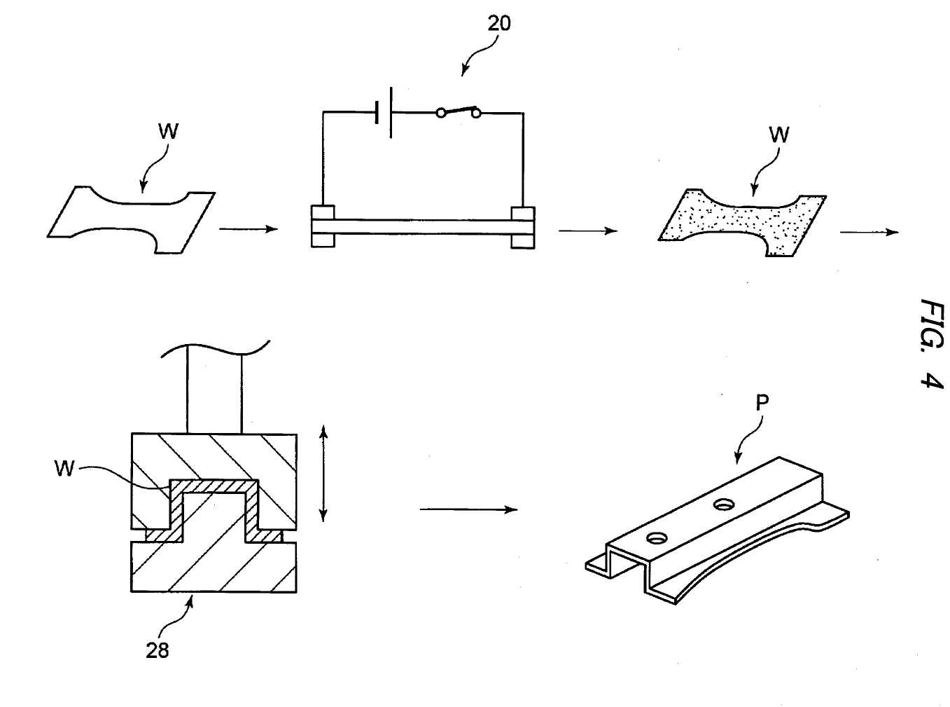

First, as shown in FIG. 4, a plate workpiece W cut into a predetermined shape is heated by direct resistance heating by a heating apparatus 20, and the pair of electrodes 23, 24 is arranged in the widthwise direction across the plate workpiece W such that the electrodes 23,24 contact the surface of the workpiece W. The plate workpiece W is heated by moving the electrodes toward one side or opposite sides in the longitudinal direction in accordance with a variation in cross sectional area along the longitudinal direction while applying electric current to the electrodes. Afterwards, the plate workpiece W being in a high temperature state is immediately pressed by a press mold 28 of a press machine, thereby forming a predetermined shaped product. When the first region 11 and the second region 12 are in a heated state, it is preferable that the workpiece be formed by pressing the first and second regions 11, 12 with the press mold 28.

According to this hot press molding method, the workpiece is pressed by the press mold 28 after the workpiece has been heated by direct resistance heating. Therefore, it is sufficient to configure the heating equipment only with simple construction such as the pair of electrodes 23, 24 or the like. Thus, the heating equipment can be provided adjacent to or integrally with the press machine. Because of this, the plate workpiece W can be press formed, by the press mold 28, in a short time after being heated. This consequently restricts a temperature drop of the heated workpiece W and therefore prevents energy loss. In addition, it is possible to shorten or even eliminate the equipment-movement time after heating, thereby preventing a surface oxidation of the plate workpiece W and thus obtaining a high-quality product P.

Further, as described before, the workpiece can be heated over a wide combined area of the first and second regions 11, 12 to be in a given temperature range. Accordingly, when the workpiece is pressed by the press mold 28, a temperature range in the deformed region is made smaller, so that a strength range of the plate workpiece W can also be made smaller. Consequently, it is possible to easily perform press molding and maintain a constant quality of product P.

Particularly, in this embodiment, the pair of electrodes 23, 24 arranged widthwise is moved in the longitudinal direction while applying electric current to the workpiece by the contact with the surface of the workpiece. Thus, at least a portion of the workpiece is first heated by direct resistance heating and then is pressed by the press mold 28. Therefore, even when the plate workpiece W has a cross sectional area that increases or decreases in the longitudinal direction, the heating temperature is prevented from being deviated by the compact-type apparatus, thereby providing a constant quality of product P.

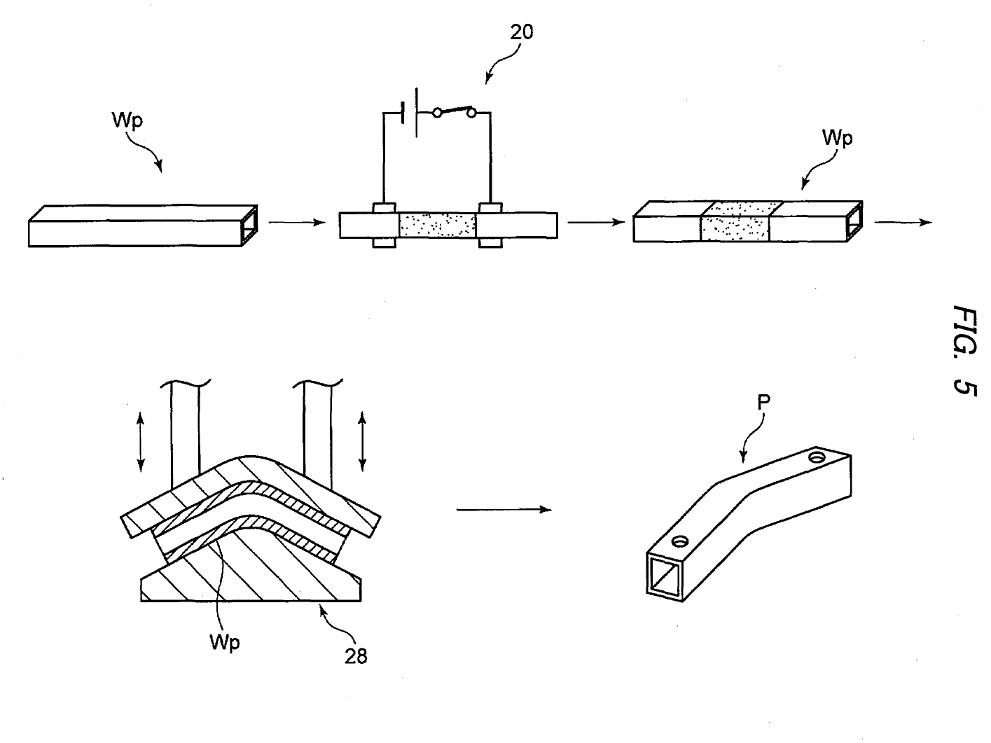

The hot press molding method of the fourth embodiment can be applied to, e.g., a hollow workpiece Wp as shown in FIG. 5. In this case, the hollow workpiece Wp having a given shape can be heated by direct resistance heating by moving the electrodes in accordance with a variation in cross sectional area of respective walls along the longitudinal direction, while applying electric current to the workpiece Wp by bring the pair of electrodes into contact with the workpiece. Immediately thereafter, the workpiece Wp being in a high temperature state is pressed by the press mold 28 of the press machine, thereby forming a product P having a predetermined shape. Such a hot press molding method can also provide similar effects as in the former embodiments.

Various changes and modifications may be made in the embodiments described above within the scope of the present invention.

For example, the present invention can be applied to the plate workpiece W having different thickness in each region. In this case, in the respective embodiments, it is preferable that the first and second regions be heated based on the respective cross sectional areas thereof in the widthwise direction, instead of the widths thereof. In addition, it is also possible to adapt the respective embodiments to heat or shape a region in which a widthwise cross sectional area is substantially uniform along the longitudinal direction, and the thickness and width are substantially uniform along the longitudinal direction.

Although the respective embodiments have illustrated an example in which one of the electrodes 23, 24 in a pair is moved when the first region 11 is heated by direct resistance heating, it is possible to move the pair of electrodes 23, 24 away from each other according to the shape of the first region 11.

Further, the length of the respective electrodes 23, 24 used in the respective embodiments is not specifically limited, but may be adequately adjusted according to a variety of conditions such as a shape, heating temperature or the like of the plate workpiece W or respective regions. Particularly, when the second region 12 is heated by bringing the pair of electrodes into contact with the second region, it is preferable that the length or shape of the respective electrodes be adequately adjusted according to the shape or position of the second region 12.

Further, although the first to third embodiments have illustrated an example of first heating the plate workpiece W and then cooling the heated workpiece, thereby performing quenching, the purpose of carrying out heating is not specifically limited. For example, the processing may be carried out in order to perform the heating only, perform other heat treatment such as tempering or annealing, or obtain other purposes such as dry or thermal hardening of a paint. In this case, it is preferable that the workpiece be heated to an optimum temperature to suit the respective purposes.

Furthermore, although the respective embodiments have illustrated an example in which the second regions 12 are provided on end sides of the plate workpiece W in the longitudinal direction, it is possible to apply the present invention to the case where the second regions 12 are provided on the intermediate portion in the longitudinal direction.

This application is based on Japanese Patent Application No. 2013-119239 filed on Jun. 5, 2013, the entire content of which is incorporated herein by reference.

1. A method of heating a plate workpiece, the plate workpiece having a first region and a second region, wherein a cross sectional area of the first region in a widthwise direction of the plate workpiece is substantially uniform along a longitudinal direction of the plate workpiece or is monotonically increased or decreased along the longitudinal direction, and wherein the second region is adjoining a portion of the first region in a monolithic manner, the method comprising:
heating the second region; and
heating at least the first region by direct resistance heating along the longitudinal direction,
wherein the second region is heated before heating the first region such that the first region and the second region are heated to be in a given temperature range.

2. The method according to claim 1, wherein a width of the first region is substantially uniform along the longitudinal direction or is monotonically increased or decreased along the longitudinal direction, and wherein the second region is adjoining the portion of the first region in the widthwise direction.

3. The method according to claim 2, wherein the plate workpiece comprises a narrow portion and a wide portion arranged along the longitudinal axis of the plate workpiece, wherein the wide portion is wider in the widthwise direction than the narrow portion, wherein the first region includes the narrow portion and an extended portion defined in the wide portion by imaginary boundary lines, the imaginary boundary lines being extensions of both side edges of the narrow portion along the longitudinal axis.

4. The method according to claim 2, wherein the heating at least the first region comprises:
arranging a pair of electrodes in the widthwise direction such that the pair of electrodes contacts a surface of the plate workpiece;
moving at least one of the electrodes with electric current being applied to the at least one of the electrodes.

5. The method according to claim 1, wherein the heating the second region comprise heating the second region to a temperature lower than the given temperature range, and wherein the heating at least the first region comprises further heating the second region together with the first region by direct resistance heating along the longitudinal direction.

6. The method according to claim 1, wherein the heating the second region comprises heating the second region to a temperature higher than the given temperature range.

7. The method according to claim 1, wherein a width of the first region is substantially uniform along the longitudinal direction or is monotonically increased or decreased along the longitudinal direction, and wherein the second region is adjoining the portion of the first region in the longitudinal direction,
wherein the heating at least the first region comprises further heating the second region together with the first region by direct resistance heating along the longitudinal direction.

8. The method according to claim 7, wherein the heating the second region comprise heating the second region to a temperature lower than the given temperature range.

9. The method according to claim 1, wherein the heating the second region comprises heating the second region by direct resistance heating, induction heating, furnace heating, or heater heating.

10. An apparatus for heating a plate workpiece, the plate workpiece having a first region and a second region, wherein a width of the first region is substantially uniform along a longitudinal direction of the plate workpiece or is monotonically increased or decreased along the longitudinal direction, and wherein the second region is adjoining a portion of the first region in a widthwise direction or the longitudinal direction of the plate workpiece in a monolithic manner, the apparatus comprising:
a first heating section configured to heat at least the first region; and
a second heating section configured to heat the second region,
wherein the first heating section comprises a pair of electrodes arranged in the widthwise direction such that the pair of electrodes contacts a surface of the plate workpiece to apply electric current to the plate workpiece.

11. The apparatus according to claim 10, wherein the second region is adjoining the portion of the first region in the widthwise direction, and wherein the first heating section further comprises a drive unit configured to move at least one of the electrodes in the longitudinal direction in accordance with a variation in a cross sectional area of the plate workpiece with electric current being applied to the at least one of the electrodes.

12. The apparatus according to claim 10, wherein the second region is adjoining the portion of the first region in the longitudinal direction, and wherein the first heating section is configured to heat the second region together with the first region.

13. A method for hot press molding a plate workpiece, the plate workpiece having a first region and a second region, wherein a cross sectional area of the first region in a widthwise direction of the plate workpiece is substantially uniform along a longitudinal direction of the plate workpiece or is monotonically increased or decreased along the longitudinal direction, and wherein the second region is adjoining a portion of the first region in a monolithic manner, the method comprising:
heating the first region and the second region; and
after the heating, pressing the first region and second region using a press mold,
wherein the heating comprises:
heating the second region; and
heating at least the first region by direct resistance heating along the longitudinal direction,
wherein the second region is heated before heating the first region such that the first region and the second region are heated to be in a given temperature range.
